(19) United States
(12) Patent Application Publication
(10) Pub. No.: US 2019/0257075 A1
(43) Pub. Date: Aug. 22, 2019

(54) ANCHOR BOLT ASSEMBLY AND ARRANGEMENT FOR CONCRETE FOUNDATION DESIGNS

(71) Applicants: Joseph W. Ball, Amherst, NY (US); Bismarck N. Luna, Lancaster, NY (US)

(72) Inventors: Joseph W. Ball, Amherst, NY (US); Bismarck N. Luna, Lancaster, NY (US)

(21) Appl. No.: 16/268,840

(22) Filed: Feb. 6, 2019

Related U.S. Application Data
(63) Continuation of application No. 62/633,732, filed on Feb. 22, 2018.

(51) Int. Cl. E04B 1/41; E02D 5/80

(52) U.S. Cl. CPC E04B 1/4135; E02D 5/801; F16B 35/00; E02D 2600/30; E04B 1/4128

(57) ABSTRACT

An anchor bolt assembly and arrangement for anchoring structure or equipment of an air separation plant to a reinforced concrete foundation is provided. The anchor bolt assembly includes one, two or more anchor bolts, each anchor bolt having a first end configured to be embedded in the concrete foundation and a threaded second end configured to be projecting from the foundation. The anchor bolt assembly further comprises a steel plate affixed to the first end of the anchor bolt(s) and extends in an orthogonal orientation to the length of the anchor bolts. The size of the steel plate is selected such that a perimeter of the steel plate is between about 0.25 and 4.0 times the embedment depth of the anchor bolt body which provides additional pull-out strength of the anchor bolt assembly. Preferably, the steel plate is disposed below to the bottom longitudinal reinforcement within the concrete foundation.

### CROSS REFERENCE TO RELATED APPLICATIONS

The present application claims the benefit of and priority to U.S. Provisional Patent Application Ser. No. 62/633,732 filed on Feb. 22, 2018, the disclosure of which is incorporated by reference herein.

### TECHNICAL FIELD

The present invention relates generally to construction techniques using anchor bolts, and more particularly, to a foundation anchor bolt assembly used to secure an air separation plant structure or piece of equipment to concrete foundations.

### BACKGROUND

Nationally recognized building codes require that structures or equipment used in an air separation plant such as cold box structures, distillation columns, heat exchangers, compressor and other turbo-machinery related equipment, pre-purification units, and pressure swing adsorption systems/vessels be secured to the foundation to safeguard against the destructive uplifting and shearing forces of seismic events and severe weather related events, i.e., strong winds, tornadoes, hurricanes, etc. The securing of such air separation plant structures and equipment is typically accomplished by connecting the frame of the structure or equipment to a concrete foundation through the use of steel anchor bolts embedded in the concrete foundation. The required thickness of the foundation and embedment depth of the anchor bolts are generally determined in accordance with the American Concrete Institute (ACI) Building Code Requirements for Structural Concrete (ACI 318-14). Anchor bolts are typically laid out in the foundation prior to pouring concrete, with threaded portions sticking up out of the concrete foundation high enough to be secured by a round washer and a nut. After the concrete cures, the anchor bolts would be used to secure the frame of the structure/equipment to the concrete foundation.

However, due to the large size of structures used in most air separation plants, conventional designs and procedures for anchoring such large structures to concrete foundations as described in ACI 318-14 Chapter 17 are not directly applicable. For example, many air separation plants have cold box structures that have a side dimension or diameter that can range from 10 feet (10′) to 17 feet (17′) and the height of such cold box structures can be up to 300 feet (300′). To secure such large structures to the on-site casted concrete foundation, very large size anchor bolts are used. Such large anchor bolts may range up to six inches (6″) in diameter with an embedment depth of six feet (6′) feet or more, whereas design using ACI 318-14 Chapter 17 is generally limited to anchors with four inch (4″) diameter and less. Some failure modes associated with anchoring of such large structures of an air separation plant with very large anchor bolts include pull-out or steel failure from excessive tensile loadings as well as concrete breakout/pryout, punching shear failures and steel failures from excessive shear loadings.

Since the traditional anchoring to concrete design procedures set forth in ACI 318-14, Chapter 17 may not be the most appropriate design philosophy for these large diameter anchor bolts because the resulting embedment depth of the anchor bolt can be prohibitively large taking into considering the magnitude of forces that could possibly be acting on the cold box structures. What is needed, therefore, is an improved anchor bolt design configured to secure air separation plant structures or equipment to reinforced concrete foundations. The inventors have developed an alternative design approach, which is based on reinforced concrete slab-column punching shear concepts developed to improve the capacity of an anchor bolt embedded in concrete foundation. Such improved anchor bolt design would preferably mitigate pull-out failures of the anchor bolt to foundation connection and potentially reduce the required embedment depth of the anchor bolts in the concrete foundation. The use of such anchor bolt design could reduce the amount of concrete used in the foundation which in turn reduces the capital cost associated with the construction of such air separation plants.

### SUMMARY OF THE INVENTION

One embodiment of the present invention may be characterized as an anchor bolt assembly for fastening a frame of a structure or a piece of equipment in an air separation plant to a concrete foundation, the anchor bolt assembly comprising: (i) one or more anchor bolts, each anchor bolt comprising an anchor bolt body defining a central axis, a length measured along the central axis and a width or diameter measured orthogonally to the central axis, the anchor bolt body further defining a first end configured to be embedded in the concrete foundation, and a threaded second end configured to be projecting from the concrete foundation; and (ii) a steel plate affixed to the first end of the one or more anchor bolts and extending in an orthogonal orientation to the central axis of each of the one or more anchor bolts, the steel plate configured to be embedded in the concrete foundation. The size of the steel plate is selected such that a perimeter of the steel plate is between about 0.25 times the embedment depth of the anchor bolt body to about 4.0 times the embedment depth of the anchor bolt body and the threaded second end of the one or more anchor bolts are configured to project from a top surface of the concrete foundation and further configured to pass through a bore on the frame or an anchor bolt chair. One or more nuts are configured to screw onto the threaded second end of each anchor bolt body to fasten the frame to the concrete foundation.

An alternate embodiment of the present invention may be characterized as an anchor bolt assembly for fastening a frame of a structure to a concrete foundation, the anchor bolt assembly comprising: (i) two or more anchor bolts, each anchor bolt comprising an anchor bolt body defining a central axis, a height measured along the central axis and a width measured orthogonally to the central axis, the anchor bolt body further defining a first end configured to be embedded in the concrete foundation, and a threaded second end configured to be projecting from the concrete foundation; and (ii) a steel plate affixed to the first end of the two or more anchor bolts and extending in an orthogonal orientation to the central axes of the one or more anchor bolts, the steel plate defining a plate length, a plate width, a plate perimeter and a plate surface area, and the steel plate configured to be embedded in the concrete foundation. Again, the threaded second end of the two or more anchor bolts are configured to project from a top surface of the concrete foundation and the frame of the structure is fastened to the concrete foundation using one or more nuts configured to screw onto the threaded second end of each anchor bolt body.

The present invention may also be characterized as a punching shear reinforced anchor bolt arrangement comprising: (a) a concrete foundation; (b) one or more anchor bolts, each anchor bolt comprising an anchor bolt body defining a central axis, a length measured along the central axis and a width or diameter measured orthogonally to the central axis, the anchor bolt body further defining a first end configured to be embedded in the concrete foundation, and a threaded second end configured to be projecting from the concrete foundation; and (c) a steel plate affixed to the first end of each of the one or more anchor bolts and extending in an orthogonal orientation to the central axis of each of the one or more anchor bolts, the steel plate configured to be embedded in the concrete foundation. The threaded second end of the one or more anchor bolts are configured to project from a top surface of the concrete foundation and further configured to pass through a bore on the frame or an anchor bolt chair. One or more nuts are configured to screw onto the threaded second end of each anchor bolt body to fasten the frame to the concrete foundation.

As described above, the size of the steel plate is selected such that a perimeter of the steel plate is between about 0.25 times the embedment depth of the anchor bolt body to 4.0 times the embedment depth of the anchor bolt body which increases the pull-out capacity of the one or more anchor bolts. Preferably, the steel plate is disposed below to the longitudinal reinforcement within the concrete foundation. In embodiments having only one anchor bolt, the first end of the anchor bolt is affixed to the steel plate proximate the center of the steel plate whereas in embodiments having two anchor bolts, the first ends of the anchor bolts are preferably affixed at a position off-center of the steel plate. The steel plate may be of a rectangular, square, circular, annular, oval or elliptical shape.

### BRIEF DESCRIPTION OF THE DRAWINGS

While the present invention concludes with claims distinctly pointing out the subject matter that Applicants regard as their invention, it is believed that the invention will be better understood when taken in connection with the accompanying drawings in which:

FIG. 1 is an illustration of a typical cryogenic air separation plant positioned on a concrete foundation;

FIG. 2 is a top plan view of a concrete foundation with embodiments of the present anchor bolt assemblies;

FIG. 3 is a cross section view of an embodiment of an anchor bolt assembly in accordance with the present invention taken along Section A-A of FIG. 2;

FIG. 4 is a partial cross section view of an embodiment of an anchor bolt arrangement in accordance with the present invention with the anchor bolt assembly of FIG. 3;

FIG. 5 is a cross section view of another embodiment of an anchor bolt assembly in accordance with the present invention taken along Section B-B of FIG. 2; and

FIG. 6 is a partial perspective view of another embodiment of an anchor bolt arrangement in accordance with the present invention with the anchor bolt assembly of FIG. 5.

### DETAILED DESCRIPTION

Turning to the drawings, there is generally shown an anchor bolt arrangement used to secure structures or equipment of an air separation plant such as cold box structures, distillation columns, heat exchangers, compressor and other turbomachinery related equipment, pre-purification units, pressure swing adsorption systems/vessels, and the like, to a reinforced concrete foundation.

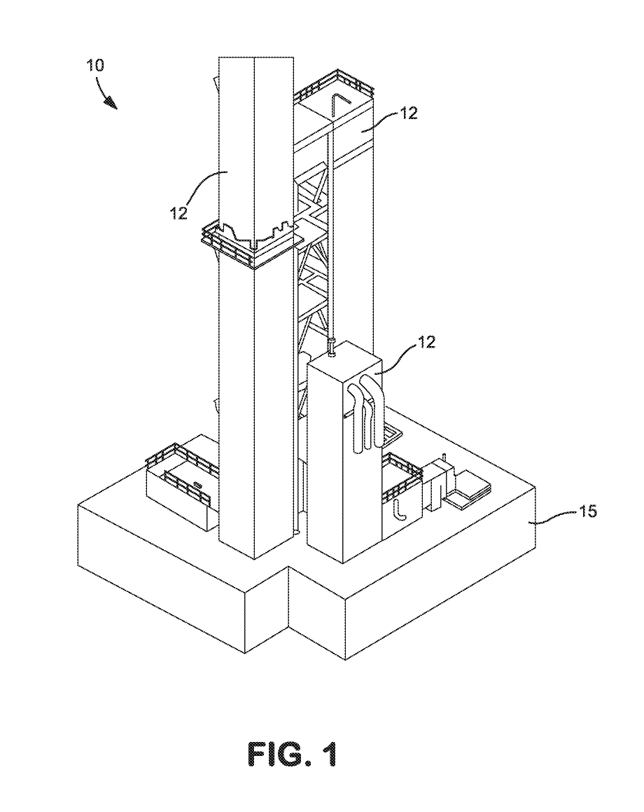

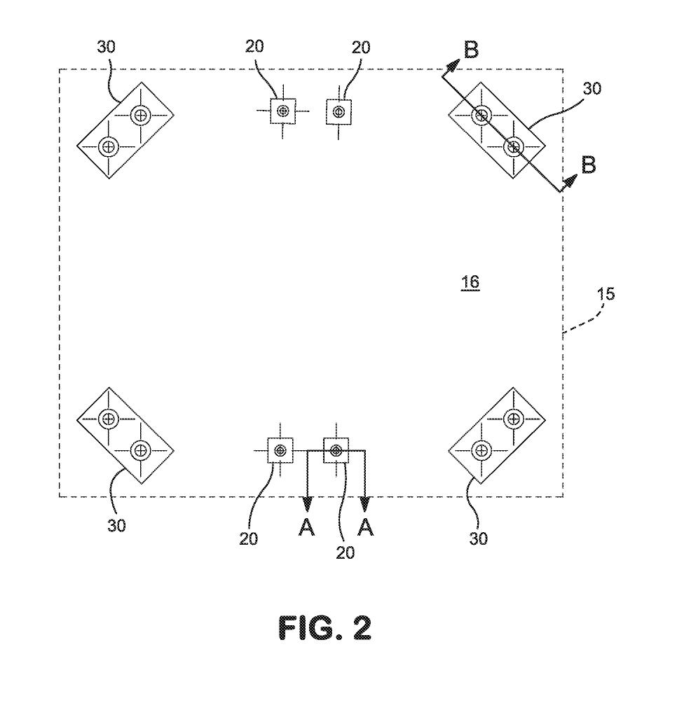

FIG. 1 depicts a cryogenic air separation plant 10 layout having a concrete foundation 15 upon which a plurality of structures, such as cold box structures 12, and other equipment are secured. FIG. 2 is an illustration of a part or portion of the concrete foundation 15 of FIG. 1 where a cold box structure 12 is to be secured and depicts several anchor bolt assemblies 20, 22 embedded within the concrete foundation 15 with a portion of the anchor bolt assemblies 20, 22 projecting up from the top surface 16 of the concrete foundation 15.

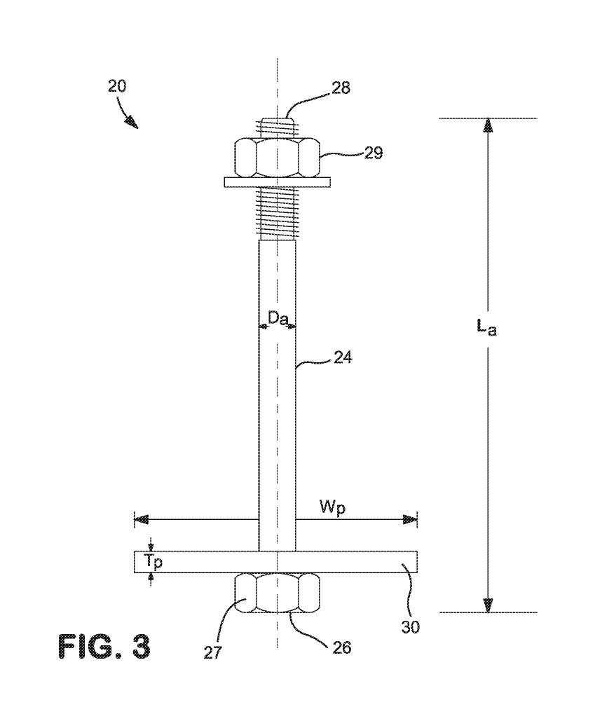

FIG. 3 is a cross section view of a first embodiment of the anchor bolt assemblies 20 preferably used to secure the side frames of the cold box structure 12 to the concrete foundation 15. The anchor bolt assembly 20 includes a long, cylindrical anchor bolt body 24 having a diameter, Dₐ and a length, Lₐ and defines a central axis along the length of the anchor bolt body 24. The anchor bolt body 24 has a first proximal end 26, preferably threaded, that is configured to be embedded in the concrete foundation 15 and a second distal end 28, preferably threaded, and that is configured to be to project upwards from the top surface 16 of the concrete foundation 15. The threaded second distal end 28 of the anchor bolt body 24 is to pass through a bore on the side portions of the frame or an anchor bolt chair of the cold box structure 12 where a nut 29 is screwed onto the threaded second distal end 28 to fasten the frame of the cold box structure 12 to the concrete foundation 15.

The anchor bolt assembly 20 further includes a steel plate 25 affixed to the first proximal end 26 of the anchor bolt body 24 and extends outwardly from the anchor bolt body 24 in directions that are generally orthogonal to the central axis. The steel plate 25 is also configured to be embedded in the concrete foundation 15. The size, shape and material properties of the steel plate 30 are selected to provide adequate pull-out strength of the anchor bolt assembly 20 and will depend on the length of the anchor bolt body 24, the embedded depth of the anchor bolt body 24 into the concrete foundation 15, the maximum expected tensile loads on the anchor bolt and shear stresses on the anchor bolt, as well as the tensile capacity of concrete. The steel plate 25 is constructed from structural steel and may be of a square or rectangular configuration, circular or annular configuration, or other polygon configuration. In the illustrated embodiment (FIG. 3), which is not to scale, anchor bolt body 24 has a diameter, Dₐ of three inches (3″) and an embedment depth length, d of about five feet (5′) that is centrally disposed on the steel plate 30. The illustrated steel plate 30 is of a square shape having a thickness Tₚ of about three inches (3″), a length, Lₚ of about 12 inches (12″), and a width, Wₚ of about 12 inches (12″). Affixing the steel plate 25 to the first proximal end 26 of the anchor bolt body 24 can be done with a nut 27, as shown in FIG. 3 or any other means of fastening such as welding, brazing, adhesives, etc. sufficient to withstand the maximum expected loads.

In this first example, the size of the steel plate is selected such that a perimeter of the steel plate (i.e. 2Wₚ+2Lₚ) is 0.8 times the embedment depth, d of the anchor bolt body and the ratio of length, Lₚ to width, Wₚ is 1.0. While the actual calculations should be done in accordance with appropriate building codes such as ACI 318-14, broadly speaking, the size of the steel plate is selected such that a perimeter of the steel plate is between about 0.25 times the embedment depth of the anchor bolt body to about 4.0 times the embedment depth of the anchor bolt body, and more preferably between 0.5 and 2.5 times the embedment depth of the anchor bolt, and with a ratio of length, Lₚ to width, Wₚ of between 1.0 and 3.0 (where Lₚ is the length of the longer side for rectangular sections).

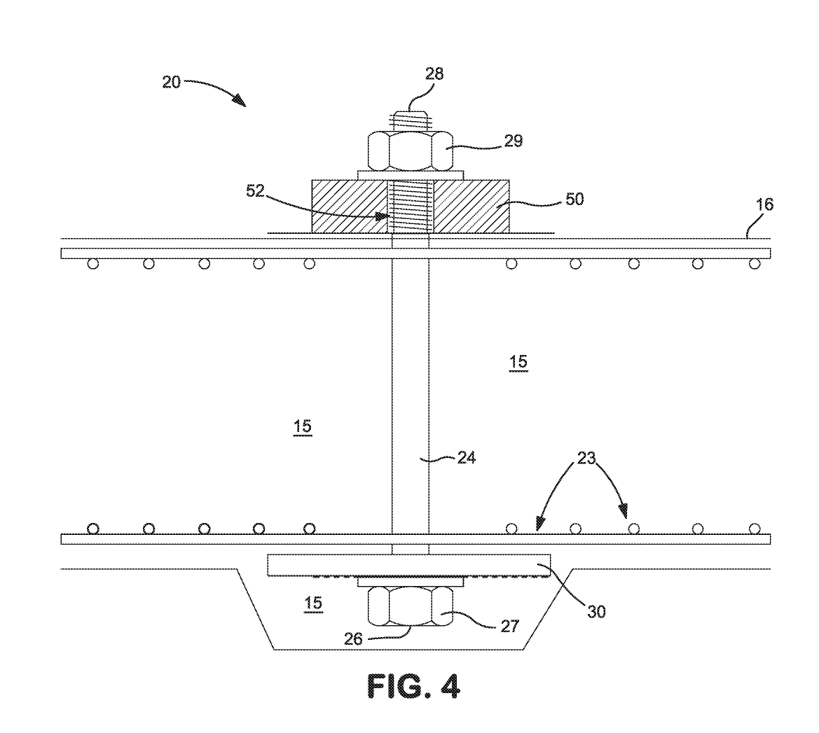

Turning now to FIG. 4, there is shown a partial cross section view of an embodiment of an anchor bolt arrangement with the anchor bolt assembly 20 of FIG. 3. The anchor bolt arrangement is shown with the anchor bolt assembly 20 partially embedded in a reinforced concrete foundation 15. The first proximal end 26 of the anchor bolt assembly 20 together with the retaining nut 27 and steel plate 25 are positioned beneath the bottom longitudinal reinforcement 23 of the concrete foundation 15. Above the concrete foundation 15, the second distal end 28 of anchor bolt body 24 passes through a bore 52 on the frame 50 or an anchor bolt chair of the cold box structure 12 and is secured by screwing and tightening one or more nuts 29 onto the threaded second distal end 28 of the anchor bolt body 24 to fasten a portion of the frame 50 of the cold box structure 12 to the concrete foundation 15. To secure the entire cold box structure 12 to the concrete foundation 15, multiple anchor bolt assemblies 20 may be positioned on each side of the cold box structure 12 or around the periphery of the cold box structure 12 to securely fasten the base of the cold box structure 12 to the concrete foundation 15.

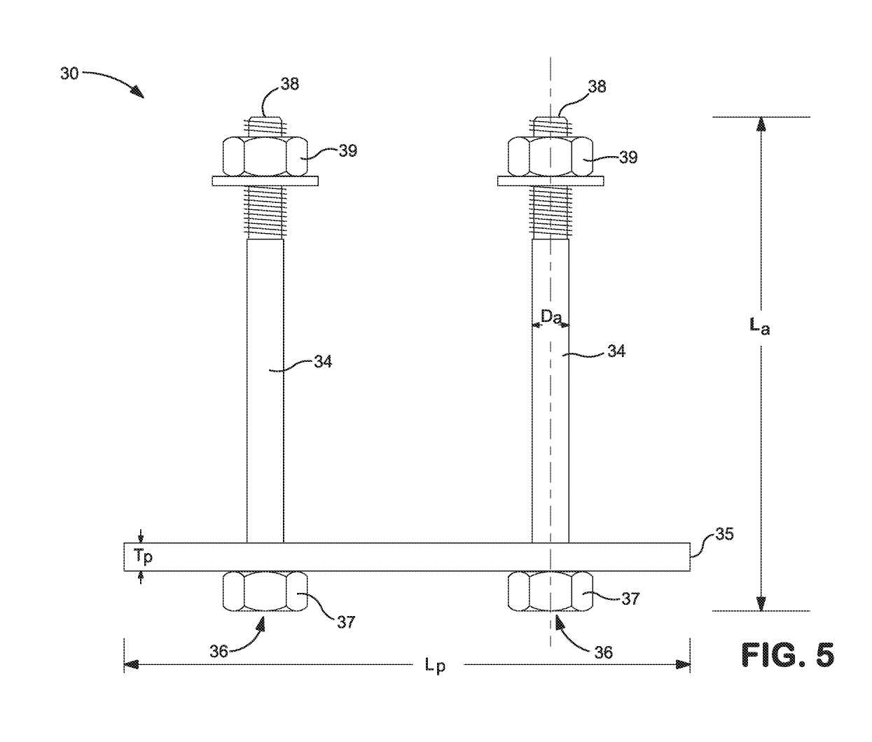

FIG. 5 is a cross section view of a second embodiment of the anchor bolt assembly 30 preferably used to secure the sides and/or corners of the cold box structure 12 to the concrete foundation 15. The anchor bolt assembly 30 includes at least two, and possibly more, anchor bolt bodies 34 each having a diameter, Dₐ and a length, Lₐ and a defined central axis along the length of each anchor bolt body 34. Each anchor bolt body 34 has a first proximal end 36, preferably threaded, that is configured to be embedded in the concrete foundation 15 and a second distal end 38, preferably threaded, and that is configured to be to project upwards from the top surface 16 of the concrete foundation 15. The threaded second distal end 38 of each anchor bolt body 34 is to pass through an anchor bolt chair or a bore preferably proximate the corner portions of the frame of the cold box structure 12 where at least one nut 39 is tightly screwed onto the threaded second distal end 38 to fasten the corners of the cold box structure 12 to the concrete foundation 15. The anchor bolt assembly 30 of FIG. 5 also includes a steel plate 35 affixed to the first proximal ends 36 of the two anchor bolt bodies 34 and that extends outwardly from the anchor bolt bodies 34 in directions that are generally orthogonal to the central axes.

Similar to the embodiment of FIG. 3, the steel plate 35 is also configured to be embedded in the concrete foundation. The size, shape and material properties of the steel plate 35 are again selected to provide adequate pull-out strength of the anchor bolt assembly and will depend on the lengths of the two or more anchor bolt bodies 34, the embedded depth of the anchor bolt body 34 into the concrete foundation, the maximum expected tensile loads on the anchor bolt and shear stresses on the anchor bolt, as well as the tensile capacity of concrete. The steel plate 35 is constructed from structural steel and may be of a rectangular, oval, elliptical or other configuration. In the illustrated embodiment, anchor bolt bodies each have a diameter, Dₐ of about six inches (6″) and an embedment depth, d of about five feet (5′) that are disposed on the steel plate in an off-center orientation. The illustrated steel plate 35 is of a rectangular shape having a thickness Tₚ of about five and one-half inches (5.5″), a length, Lₚ of about 44 inches (44″), and a width, Wₚ of about 22 inches (22″). Affixing the steel plate 35 to the first proximal end 36 of each anchor bolt body 34 can be done with one or more retaining nuts 37.

In this second example, the size of the steel plate is selected such that a perimeter of the steel plate (i.e. 2Wₚ+2Lₚ) is 2.2 times the embedment depth, d of the anchor bolt body and the ratio of length, Lₚ to width, Wₚ is 2.0. Again, while the actual design calculations should be done in accordance with appropriate building codes such as ACI 318-14, broadly speaking, the size of the steel plate is selected such that a perimeter of the steel plate should be between about 0.25 to 4.0 times the embedment depth of the anchor bolt body and with a ratio of length, Lₚ to width, Wₚ of between 1.0 and 3.0 (where Lₚ is the length of the longer side of the rectangle).

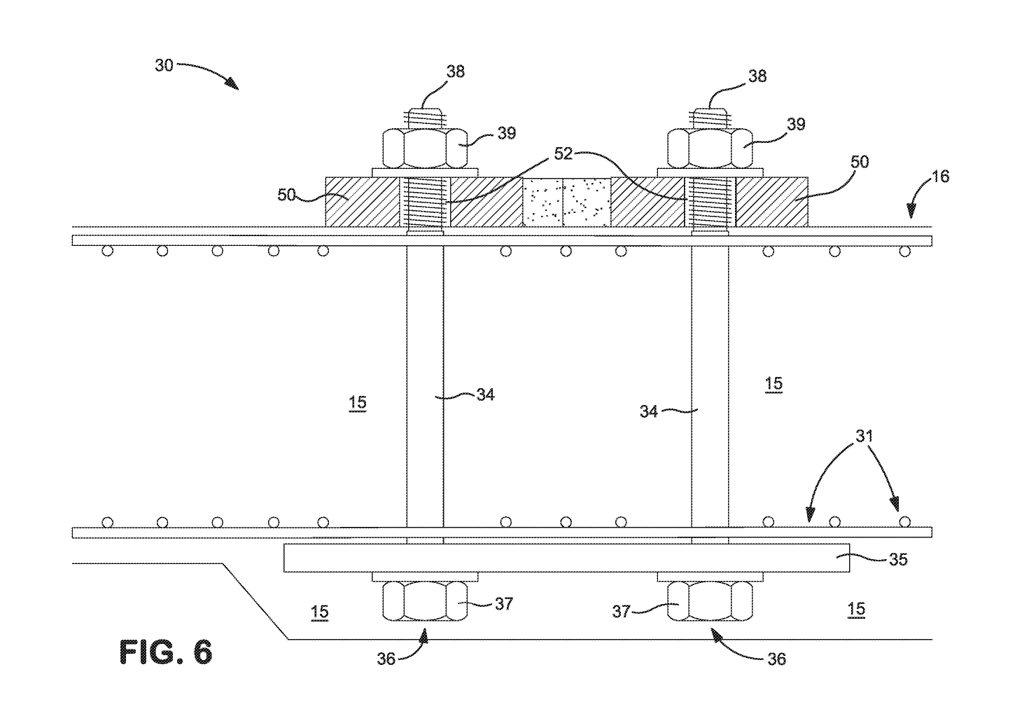

Turning now to FIG. 6, there is shown a view of an embodiment of an anchor bolt arrangement with the anchor bolt assembly 30 of FIG. 5. The anchor bolt arrangement is shown with the anchor bolt assembly 30 partially embedded in a reinforced concrete foundation 15. The first proximal end 36 of each of the two anchor bolt bodies 34 together with the associated retaining nuts 37 and steel plate 35 are positioned beneath the bottom longitudinal reinforcement 31 of the concrete foundation 15. Above the concrete foundation 15, the second distal ends 38 of both anchor bolt bodies 34 pass through a bore 52 on the frame 50 or an anchor bolt chair of the cold box structure 12 proximate the corner and are secured by screwing nuts 39 onto the threaded second distal ends 37 of each anchor bolt body 34. To secure the entire cold box structure 12 to the concrete foundation 15, multiple anchor bolt assemblies 30 may be positioned on each corner of the cold box structure to securely fasten the base of the cold box structure 12 to the concrete foundation 15.

While the anchor bolt assembly 30 of FIG. 5 having multiple anchor bolt bodies 34 and the anchor bolt arrangement of FIG. 6 are shown and described as a corner anchor bolt arrangement, it is fully contemplated that one could align the two or more anchor bolt bodies 34 and steel plate 35 along a straight side edge of the cold box structure 12. Similarly, the anchor bolt arrangement is not limited to having two anchor bolt bodies 34, but may be configured to include three, four, or more anchor bolt bodies 34 with a single steel plate 35.

In addition, when using either embodiment of the anchor bolt arrangement described with reference to FIGS. 3-4 or FIGS. 5-6, the presence of the steel plate could result in a reduction of the embedment depth of the anchor bolts in the concrete foundation compared to conventional anchor bolts used in air separation plants because the added steel plate provides larger pull-out capacity of the anchor bolt assembly. Moreover, the use of the present improved anchor bolt assembly would also reduce the amount of concrete used in the foundation compared to conventional concrete foundations in air separation plants.

### Examples

In the Praxair foundation design using the punching shear concept, strength design or load and resistance factor design (LRFD) should be used. In general, similar to other LRFD design procedures, the factored load on the anchor bolt should be less than or equal to the design capacity or reduced nominal capacity of the bolt-foundation connection. The following equation should be satisfied for the maximum load on the anchor bolt:

Tᵤ≤ϕ_{c}*v_{c}*b₀*d

where: Tᵤ is the maximum factored load on the anchor bolt;
ϕ_{c} is the strength reduction factor for shear in concrete;
v_{c} is the stress corresponding to nominal two-way shear strength of concrete;
b₀ is the critical shear perimeter; and
d is the effective depth.

As indicated above, when determining the maximum factored tensile load on the anchor bolt, Tᵤ, LRFD load combinations should be used. Applicable LRFD load combinations listed in IBC2015 Section 1605.2 and/or ASCE 7-16 Chapter 2.3 should all be considered in the determination of Tᵤ.

The strength reduction factor for shear in concrete, ϕ_{c}, shall be taken as 0.75 while the stress corresponding to nominal two-way shear strength provided by concrete, v_{c} that is determined as the minimum of the two expressions below:

3λ\sqrt{f_{c}} or [2+4/β]λ\sqrt{f_{c}} (for rectangular columns)

where: f_{c} is the concrete compressive strength in psi;
λ is equal to 1 for normal weight concrete; and
β is the ratio of the longer side to the shorter side of the steel plate.

If high strength concrete will be used, the value off, should not exceed 10,000 psi. The 3λ√f_{c}, which is smaller than what is recommended in ACI 318-14, is a conservative value often used by persons skilled in the art of concrete foundation design.

The critical shear perimeter, bₒ, is equal to 2*(Lₚ+d)+2*(Wₚ+d) where Lₚ is the length of the steel plate (i.e. longer side of the steel plate), Wₚ is the width of the steel plate (i.e. shorter side of the steel plate, and d is the embedment depth which is equal to the vertical distance from the top bearing surface of the steel plate to the surface of concrete foundation.

In determining the preferred thickness of the steel plate, t, the steel plate should be treated as a base plate and the AISC Design Guide 1 formulation for thickness can be used. In general, the maximum bending moment on the steel plate resulting from the tensile load on anchor bolt should be less than or equal to the reduced nominal plastic moment of the steel plate cross-section. The stiffness of the steel plate can affect the geometry of the concrete breakout cone. To provide additional stiffness to the steel plate, a secondary plate or washer is preferably placed beneath the steel plate. Dimensions of the secondary washer are preferably no more than about half the size and half the thickness of the steel plate.

Table 1 identifies the size and shape of selected critical parameters of the anchor bolt assembly of FIG. 3 together with selected critical parameters of anchor bolt arrangements of FIG. 4 used with a concrete foundation for a cold box structure of a cryogenic air separation plant.

TABLE 1

| Parameter | Value | | Description |
|---|---|---|---|
| Shape | Square | | Shape of Steel Plate |
| t | 3 | inches | Thickness of Steel Plate |
| Lₚ | 12 | inches | Length of Steel Plate |
| Wₚ | 12 | inches | Width of Steel Plate |
| d | 60 | inches | Embedment depth of Anchor Body |
| f_{c} | 4000 | psi | Concrete compressive strength |
| λ | 1 | | e.g. normal weight concrete |
| β | 1.0 | | Ratio of Length of Steel Plate, Lₚ to Width |
| | | | of Steel Plate Wₚ |
| φ_{c} | 0.75 | | Strength reduction factor for shear in |
| | | | concrete |
| bₒ | 288 | inches | Critical shear perimeter = 2 * (Lₚ + d) + |
| | | | 2 * (Wₚ + d) |
| v_{c} | 190 | psi | Shear capacity |

The nominal tensile capacity of the anchor bolt assembly is the product of the shear capacity v_{c}, critical perimeter bₒ, and depth d. The pullout strength of the present anchor bolt assembly is adequate if the maximum factored load Tᵤ is less than or equal to the reduced nominal tensile capacity of the anchor bolt assembly (nominal tensile capacity multiplied by the strength reduction factor for shear in concrete ϕ_{c}), which can be expressed as: Tᵤ≤ϕ_{c}*v_{c}*bₒ*d.

Table 2 identifies the size and shape of selected critical parameters of the anchor bolt assembly of FIG. 5 together with selected critical parameters of anchor bolt arrangements of FIG. 6 used with a concrete foundation for a cold box structure of a cryogenic air separation plant.

TABLE 2

| Parameter | Value | | Description |
|---|---|---|---|
| Shape | Rectangle | | Shape of Steel Plate |
| t | 5.5 | inches | Thickness of Steel Plate |
| Lₚ | 44 | inches | Length of Steel Plate |
| Wₚ | 22 | inches | Width of Steel Plate |
| d | 60 | inches | Embedment depth of Anchor Body |
| f_{c} | 4000 | psi | Concrete compressive strength |
| λ | 1 | | e.g. normal weight concrete |
| β | 2.0 | | Ratio of Length of Steel Plate, Lₚ to Width |
| | | | of Steel Plate Wₚ |
| φ_{c} | 0.75 | | Phi reduction factor for shear in concrete |
| bₒ | 372 | inches | Critical shear perimeter = 2 * (Lₚ + d) + |
| | | | 2 * (Wₚ + d) |
| V_{c} | 190 | psi | Shear capacity |

Again, the nominal tensile capacity of the anchor bolt assembly is the product of the shear capacity v_{c}, critical perimeter bₒ, and depth d. The pullout strength of the present anchor bolt assembly is adequate if the maximum factored load Tᵤ is less than or equal to the reduced nominal tensile capacity of the anchor bolt assembly (ϕc*v_{c}*bₒ*d), which can be expressed as: Tᵤ≤ϕ_{c}*v_{c}*bₒ*d.

Although the present anchor bolt arrangement for securing various structures or equipment of an air separation plant to a reinforced concrete foundation has been discussed with reference to one or more preferred embodiments, as would occur to those skilled in the art that numerous changes and omissions can be made without departing from the spirit and scope of the present invention as set forth in the appended claims.

What is claimed is:

1. An anchor bolt assembly for fastening a frame of a structure or a piece of equipment in an air separation plant to a concrete foundation, the anchor bolt assembly comprising:
one or more anchor bolts, each anchor bolt comprising an anchor bolt body defining a central axis, a length measured along the central axis and a width or diameter measured orthogonally to the central axis, the anchor bolt body further defining a first end configured to be embedded in the concrete foundation, and a threaded second end configured to be projecting from the concrete foundation;
a steel plate affixed to the first end of the one or more anchor bolts and extending in an orthogonal orientation to the central axis of each of the one or more anchor bolts, the steel plate configured to be embedded in the concrete foundation;
wherein the size of the steel plate is selected such that a perimeter of the steel plate is between about 0.25 times the embedment depth of the anchor bolt body to about 4.0 times the embedment depth of the anchor bolt body;
wherein the threaded second end of the one or more anchor bolts are configured to project from a top surface of the concrete foundation and further configured to pass through a bore on the frame or an anchor bolt chair; and
one or more nuts configured to screw onto the threaded second end of each anchor bolt body to fasten the frame to the concrete foundation.

2. The anchor bolt assembly of claim 1 wherein the steel plate additional pull-out strength of the anchor bolt assembly.

3. The anchor bolt assembly of claim 1 wherein the steel plate is further configured to be disposed below to the bottom longitudinal reinforcement within the concrete foundation.

4. The anchor bolt assembly of claim 1 wherein the first end of each of the one or more anchor bolts is a threaded first end and the steel plate is fastened to the threaded first end of each of the one or more anchor bolts using one or more nuts.

5. The anchor bolt arrangement of claim 1 wherein there is one anchor bolt and the first end of the anchor bolt is affixed to the steel plate proximate the center of the steel plate.

6. The anchor bolt arrangement of claim 1 wherein there are two anchor bolts and the first ends of the anchor bolts are affixed to the steel plate at a position off-center of the steel plate.

7. The anchor bolt arrangement of claim 1 wherein steel plate has a rectangular or square shape.

8. The anchor bolt arrangement of claim 1 wherein steel plate has a circular or annular shape.

9. The anchor bolt arrangement of claim 1 wherein steel plate has an oval or elliptical shape.

10. A steel plate-anchor bolt arrangement comprising:
a concrete foundation;
one or more anchor bolts, each anchor bolt comprising an anchor bolt body defining a central axis, a length measured along the central axis and a width or diameter measured orthogonally to the central axis, the anchor bolt body further defining a first end configured to be embedded in the concrete foundation, and a threaded second end configured to be projecting from the concrete foundation;
a steel plate affixed to the first end of each of the one or more anchor bolts and extending in an orthogonal orientation to the central axis of each of the one or more anchor bolts, the steel plate configured to be embedded in the concrete foundation;
wherein the size of the steel plate is selected such that a perimeter of the steel plate is between about 0.25 times the length of the anchor bolt body to about 4.0 times the length of the anchor bolt body;
wherein the threaded second end of each of the one or more anchor bolts are configured to project from a top surface of the concrete foundation and further configured to pass through a bore on a frame or an anchor bolt chair of a structure; and
one or more nuts configured to screw onto the threaded second end of each anchor bolt body to fasten the frame to the concrete foundation.

11. The anchor bolt arrangement of claim 10 wherein the steel plate provides additional pull-out strength of the anchor bolt assembly.

12. The anchor bolt arrangement of claim 10 wherein the steel plate is further configured to be disposed below to the longitudinal reinforcement within the concrete foundation.

13. The anchor bolt arrangement of claim 10 wherein the first end of each of the one or more anchor bolts is a threaded first end and the steel plate is fastened to the threaded first end of each of the one or more anchor bolts using one or more nuts.

14. The anchor bolt arrangement of claim 10 wherein there is one anchor bolt and the first end of the anchor bolt is affixed to the steel plate proximate the center of the steel plate.

15. The anchor bolt arrangement of claim 10 wherein there are two anchor bolts and the first ends of the anchor bolts are affixed to the steel plate at a position off-center of the steel plate.

16. The anchor bolt arrangement of claim 10 wherein steel plate has a rectangular shape.

17. The anchor bolt arrangement of claim 10 wherein steel plate has a circular or annular shape.

18. The anchor bolt arrangement of claim 10 wherein steel plate has an oval or elliptical shape.

19. The anchor bolt arrangement of claim 10 wherein the frame is the frame of a cold box structure of a cryogenic air separation plant.

20. The anchor bolt arrangement of claim 10 wherein the frame is a frame of a piece of equipment of an air separation plant.

21. The anchor bolt arrangement of claim 10 wherein the concrete foundation has a first thickness of at locations spaced apart from the steel plate and a second thickness at locations proximate the steel plate, wherein the second thickness is greater than the first thickness.

22. An anchor bolt assembly for fastening a frame of a structure to a concrete foundation, the anchor bolt assembly comprising:
two or more anchor bolts, each anchor bolt comprising an anchor bolt body defining a central axis, a height measured along the central axis and a width measured orthogonally to the central axis, the anchor bolt body further defining a first end configured to be embedded in the concrete foundation, and a threaded second end configured to be projecting from the concrete foundation;
a steel plate affixed to the first end of the two or more anchor bolts and extending in an orthogonal orientation to the central axes of the one or more anchor bolts, the steel plate defining a plate length, a plate width, a plate perimeter and a plate surface area, and the steel plate configured to be embedded in the concrete foundation;
wherein the threaded second end of the two or more anchor bolts are configured to project from a top surface of the concrete foundation; and
one or more nuts configured to screw onto the threaded second end of each anchor bolt body to fasten the frame of the structure to the concrete foundation.

23. The anchor bolt assembly of claim 22 wherein the steel plate provides additional pull-out strength of the anchor bolt assembly.

24. The anchor bolt assembly of claim 22 wherein the steel plate is further configured to be disposed below to the bottom longitudinal reinforcement within the concrete foundation.

25. The anchor bolt assembly of claim 22 wherein the first end of each of the two or more anchor bolts is a threaded first end and the steel plate is fastened to the threaded first end of each of the two or more anchor bolts using one or more nuts.

26. The anchor bolt arrangement of claim 22 wherein steel plate has a rectangular shape.

27. The anchor bolt arrangement of claim 22 wherein steel plate has an oval or elliptical shape.
